(19) United States
(12) Patent Application Publication
(10) Pub. No.: US 2004/0131216 A1
(43) Pub. Date: Jul. 8, 2004

(54) Light assembly system for a loudspeaker

(75) Inventor: Kurt Solland, Westlake Village, CA (US)

Correspondence Address: PLUMSEA LAW GROUP, LLC, 10411 MOTOR CITY DRIVE, SUITE 320, BETHESDA, MD, 20817, US

(73) Assignee: Harman International Industries, Inc., Northridge, CA

(21) Appl. No.: 10/336,854

(22) Filed: Jan. 6, 2003

(51) Int. Cl. H04R 1/02; H04R 9/06

(52) U.S. Cl. 381/332; 381/87

(57) ABSTRACT

An audio speaker with a distinctive light assembly is disclosed. The light assembly uses a light disk and a cover to create the effect that an observer is being followed by a ray of light produced by the light assembly. This effect can also be experienced by multiple observers located at different positions about the light assembly.

### BACKGROUND

1. Field of the Invention

This invention relates to a loudspeaker with a light assembly.

2. Related Art

A few audio loudspeakers today include some kind of light indicator as a part of the enclosure. Generally, the light is used to indicate that the loudspeaker is receiving power and is ready for operation. Lights on loudspeakers have been simple and crude and used solely as an indicia or indicator.

Generally, lights associated with audio speakers in the related art have not included any effect or optical features. They have been purely utilitarian and have lacked any aesthetic aspect or other than displaying operational characteristics.

### SUMMARY

This invention is directed to a light assembly system for a loudspeaker and a generic light assembly. The invention provides a light assembly that produces a unique lighting effect. As observers look at the light assembly, an unblocked area facing the observer appears to be illuminated while the remaining unblocked areas appear dark or less bright.

If the observer moves, the illuminated unblocked area appears to follow the observer as the observer moves. This creates the effect that the illuminated area is following the observer and that the observer is being “watched” by the light assembly as the observer moves relative to the light assembly.

The loudspeaker may also include an enclosure having at least one transducer and a light assembly associated with the enclosure. The light assembly includes a light source, a cover and a light disk. The light disk includes a generally circular portion extending at least 100°, the cover includes an outer periphery that generally corresponds to the outer periphery of the light disk.

The light disk may also include a centrally located hole to receive the light source. To aid in distributing light from the light source, the light disk may also include a centrally located second hole or recess. This second hole may be disposed opposite the hole containing the light source and the second hole or recess may have a conical shape.

A cover may be used in conjunction with the light disk to enhance the optical effect. The cover may include one or more fingers that extend towards the light disk. These fingers may cover portions of the light disk creating a pattern of covered and uncovered regions or areas. This pattern can enhance the optical effect by selectively blocking certain rays of light.

The light assembly may be circular or arcuate in shape. In those cases where the light assembly is circular, the light assembly can extend about 360° or if the light assembly is nearly circular, it can extend about 350°. In other cases, the light assembly is arcuate and extends around only a portion of the loudspeaker. In these cases, the light assembly may extend about 180° or less.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an isometric view of a loudspeaker having a light assembly system.

FIG. 2 is a cross-sectional view of a light assembly system.

FIG. 3 is an exploded isometric view of a light assembly system.

FIG. 4 is an enlarged cross-sectional view of a light assembly system.

FIG. 5 is a schematic top view of a light assembly system.

### DETAILED DESCRIPTION OF THE PREFERRED EMBODIMENTS

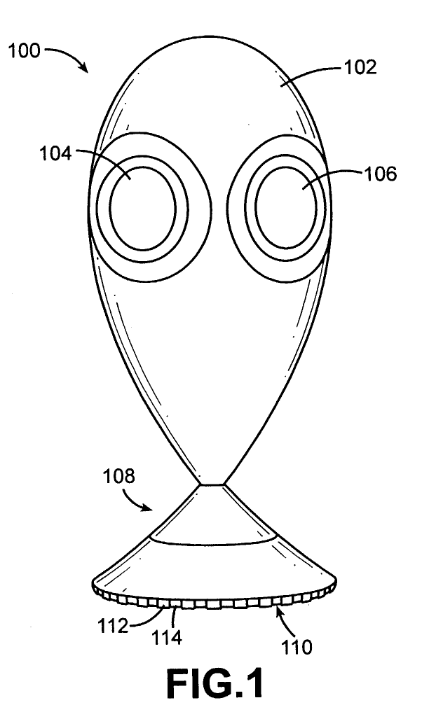

FIG. 1 is an isometric view of an illustrative embodiment of a loudspeaker 100. Speaker 100 includes an enclosure 102 and at least one transducer. In the embodiment shown in FIG. 1, speaker 100 includes a first transducer 104 and a second transducer 106 associated with enclosure 102. These transducers convert an input signal into an audible output.

Speaker 100 also includes a lower portion 106 that acts as a stand. In this embodiment, the lower portion 108 includes a light assembly 110. In some embodiments, lower portion 108 optionally includes a volume control.

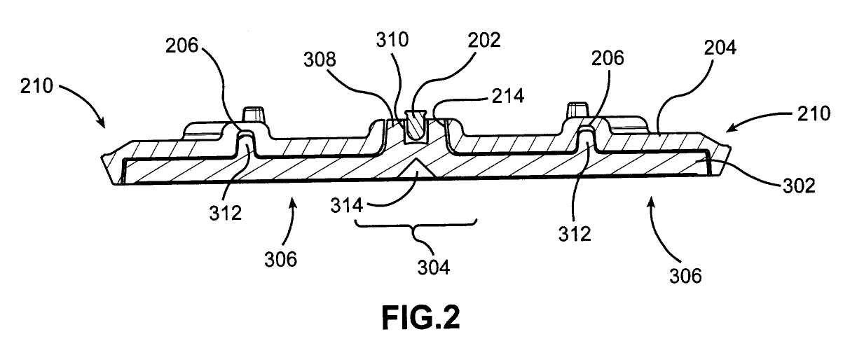

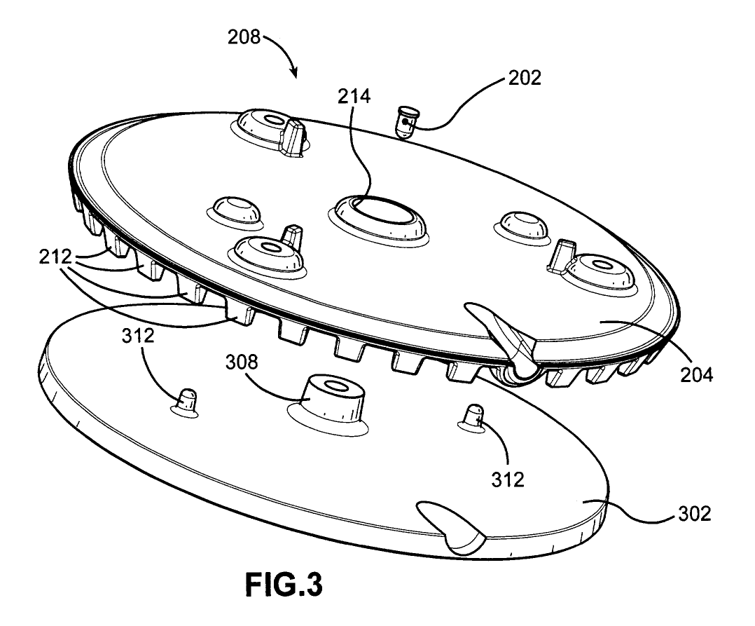

FIG. 2, which is a cross-sectional view of light assembly 110 and FIG. 3, which is an exploded isometric view of light assembly 110, show various details of light assembly 110. Referring to FIGS. 2 and 3, light assembly includes a light source 202, a cover 204, and a light disk 302.

Light source 202 can be any illuminating device, however, a Light Emitting Diode (LED) is preferred. Light source 202 can emit any desired color of light. In one embodiment, light source 202 emits blue light.

Light disk 302 may be made of a transparent material, generally circular in shape, and may include a central portion 304 and an outer portion 306. Light disk 302 may extend in an arc, for example, 100° or 180°, or in a generally circular disk extending about 360°.

Central portion 304 of light disk 302 includes a centrally located boss 308 that includes a hole 310. Hole 310 is appropriately sized and designed to receive light source 202. Hole 310 may be a blind or stopped hole, and does not have to extend through light disk 302. Boss 308 may extend through a central hole 214 in cover 204 that is appropriately sized and designed to receive boss 308, as shown in FIG. 2. Recess 314 may be disposed in light disk 302 opposite and axially aligned with boss 308. Recess 314 also may be a blind or stopped hole that does not extend entirely through light disk 302. Recess 314 may have a unique shape that reflects light from light source 202 in a predetermined manner, as disclosed below.

Light disk 302 may include at least one aligning projection 312. Aligning projection 312 extends from light disk 302 towards cover 204. Aligning projection 312 is used to assist in aligning light disk 302 with cover 204 to facilitate assembly. The exemplary embodiment disclosed in FIG. 2 has three aligning projections 312. The three aligning projections 312 are equally spaced circumferentially from each other on a selected radius. Because there are three aligning projections, they are preferably spaced 120° from each other. Any number and configuration of aligning projections is contemplated to be within the scope of the invention.

Cover 204 may include a corresponding number of alignment holes 206 designed to receive the aligning projections 312 of light disk 302. Cover 204 can also include provisions 208 that assist in associating cover 204 with other parts of speaker 100. Although alignment projections mating alignment holes are shown, any other structures to align the disks relative to one another such as pin and slot or mating camming projections are contemplated to be within the scope of the invention.

The outer periphery 210 of cover 204 includes one or more fingers 212. These fingers 212 project axially towards light disk 302 and are disposed radially outward of light disk 302. Given this arrangement, fingers 212 cover circumferential portions of light disk 302 and form a pattern of blocked areas 112 alternating with areas that are not blocked 114, as shown in FIG. 1.

The arrangement of light source 202, cover 204, and light disk 302 produces a distinctive lighting effect. As observers look at light assembly 110, the unblocked area 114 facing the observer appears to be illuminated, while the remaining unblocked areas 114 that do not face the observer appear dark. In other words, the unblocked area 114 that is on a ray from the observer to light source 202 will appear illuminated while unblocked areas 114 that are not on that ray will appear dark.

If the observer moves, the illuminated unblocked area appears to follow the observer as the observer moves, creating the effect that the observer is being “watched” by the light assembly 110 as the observer moves relative to speaker 100.

Also, if multiple observers look at light assembly 110, they all will experience the same effect as a single observer, even if the observers look at light assembly 110 from different directions or locations. Regardless of direction or location, all of the multiple observers will see only the unblocked area 114 facing them to be illuminated while the other unblocked areas 114 will be dark. As the multiple observers move relative to light assembly 110, they will all appear to be followed by the illuminated unblocked area 114. The following description describes how the optical effects operate.

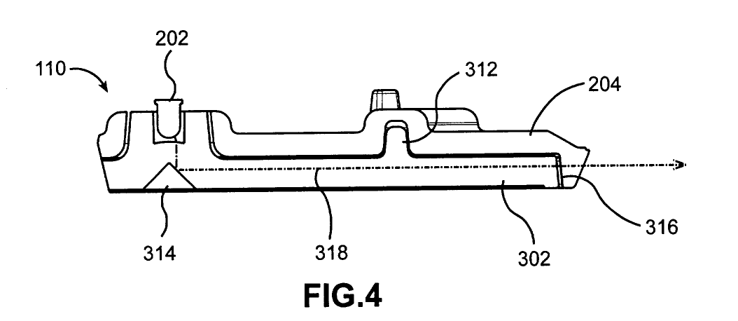

FIG. 4 is an enlarged cross-sectional view of light assembly 110 depicting the radial emission of light through outer portion 316 of light disk 302. Recess 314 may be in the general shape of a cone, meaning that a cone-shaped portion is removed from light disk 302.

Generally, when light passes from one medium having a first index of refraction to a second medium having a different index of refraction, the light is refracted even if the second medium is transparent. As shown in FIG. 4, as light 318 from light source 202 travels towards recess 314, the light eventually contacts the surface of recess 314. Because the index of refraction of light disk 302 is different than the index of refraction of air, the light 318 will be internally reflected through light disk 302 and will travel in a generally radial direction. If the cone is circular, light will travel from the center of light disk 302 evenly throughout the entire circular extent of light disk 302 or arcuate portion if the light disk 302 is less than 360°.

The size and angle of the cone is designed so that light emitted from light source 202 is reflected in a radial direction towards the radially outer portion 316 of light disk 302. The size and angle of the cone depends on a number of factors, including geometry and the index of refraction of the material of light disk 302. In one embodiment, the size and angle of the cone may be selected in order to reflect the maximum amount of light from light source 202 to the radially outer portion 316 of light disk 302. Although any suitable material can be used, in an exemplary embodiment, light disk 302 may be made of polycarbonate, which has an index of refraction of 1.58. Given this material and index of refraction, a cone altitude of 3.5 mm and a cone angle of 90° may be selected to maximize radial light output. Other suitable materials include any transparent or semi-transparent material, such as acrylic.

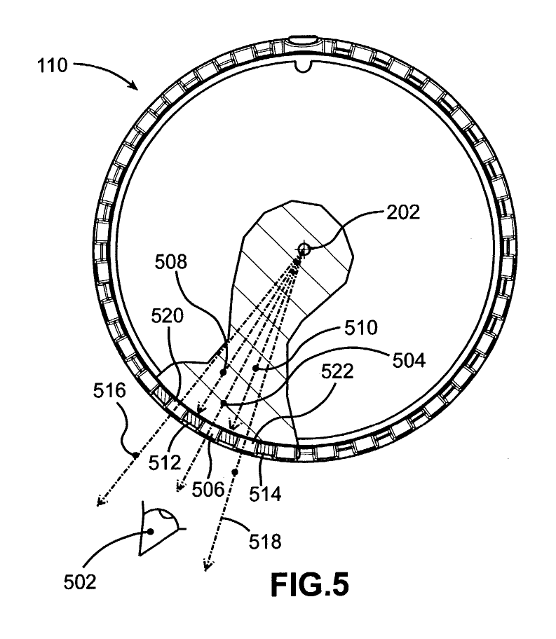

After the light is properly transmitted radially through light disk 302, various features of light assembly 110 cooperate to produce the apparent light following effect. Referring to the embodiment shown in FIG. 5, as observer 502 looks at light assembly 110, first ray of light 504 emanating from light source 202 and aligned with observer 502 will eventually reach observer 502. First ray of light 504 will also travel through a first unblocked portion 506 that is along first ray of light 504 and disposed between observer 502 and light source 202.

Second ray of light 508 is adjacent to first ray of light 504 in a clockwise direction and third ray of light 510 is adjacent to first ray of light 504 in a counter clockwise direction. Second ray of light 508 is radially aligned with first finger 512 and is therefore blocked from view. Likewise, third ray of light 510 is aligned with second finger 514 and is also blocked from view. Fingers 512 and 514 adjacent to the aligned unblocked portion 506 act to block adjacent rays of light and assist in creating the optical effect that only aligned unblocked portion 506 is emitting light. Fingers like 512 and 514 may be disposed in radial locations around light assembly 110 to create the optical effect in an arc or circle.

Fourth ray of light 516 is adjacent to second ray of light 508 in the clockwise direction and fifth ray of light 518 is adjacent to third ray of light 510 in the counter clockwise direction. Although these rays of light are aligned with second and third unblocked portions 520 and 522 respectively, and therefore emit beyond the cover 204 and fingers 212 (see FIG. 3), they are not visible to observer 502 because those rays of light are outside of the observer's 502 field of view. Fourth and fifth rays of light 516 and 518, however, may be visible to another observer (not shown) who is positioned in another location from which the assembly 110 is visible.

This arrangement produces the effect to observer 502 that only one unblocked portion is lit while the remaining unblocked portions are generally not lit. In some cases, depending on ambient light, distance of the observer from the light assembly, and the intensity of the light source, adjacent unblocked portions 520 and 522 can appear slightly lit when compared to the aligned unblocked portion 506. Whether the adjacent unblocked portions 520 and 522 appear illuminated or not, in general, the aligned unblocked portion 506 will have a first apparent intensity and the adjacent unblocked portions 520 and 522, as well as the remaining unblocked portions will have a second apparent intensity, that is less than the first apparent intensity to that observer.

As the observer 502 moves relative to light assembly 110, different unblocked portions will appear lit while the remaining unblocked portions appear dim or dark. This will create the effect that the observer 502 is being followed by light assembly 110. As discussed above, the same effect is experienced by multiple observers located at different locations around light assembly 110 at the same time.

The recess 314 may be shaped differently to enhance the optical effect. For example, the cone may be faceted to enhance refraction, or treated with a surface coating to emit a desired effect.

While various embodiments of the invention have been described, it will be apparent to those of ordinary skill in the art that may more embodiments and implementations are possible that are within the scope of the invention. Accordingly, the invention is not to be restricted except in light of the attached claims and their equivalents.

What is claimed is:

1. A loudspeaker comprising:
an enclosure having at least one transducer, the transducer converting an input signal to an audible output;
a light assembly associated with the enclosure where the light assembly includes a light source, a cover, and a light disk;
where the light disk includes a generally circular portion, the cover includes an outer periphery that generally corresponds to the outer periphery of the light disk, and is axially spaced from the light disk; and
where the light disk includes a centrally located hole to receive the light source.

2. The speaker according to claim 1, where the light disk and the cover extend at least 180°.

3. The speaker according to claim 1, where the light disk and the cover extend at least 350°.

4. The speaker according to claim 1, where the light disk includes a centrally located second hole having a conical shape.

5. The speaker according to claim 1, where the cover includes at least one finger extending towards the light disk and covering a portion of an outer periphery of the light disk.

6. The speaker according to claim 1, where the light disk includes at least one projection directed towards the cover and where the cover includes at least one hole to receive the projection.

7. A speaker comprising:
an enclosure;
a light assembly associated with the enclosure, the light assembly including a cover and a light disk;
where the cover is axially spaced from the light disk; and
where the light disk includes a hole disposed on a first side to receive a light source and a recess disposed on a second.

8. The speaker according to claim 7, where the cover includes a series of fingers creating alternating covered and uncovered areas on an outer periphery of the light assembly.

9. The speaker according to claim 8, where a first plurality of uncovered areas appear illuminated and a second plurality of uncovered areas appear dark.

10. The speaker according to claim 8, where a single uncovered area appears illuminated and remaining uncovered areas appear dark.

11. The speaker according to claim 8, where an aligned ray of light is visible to an observer and adjacent rays of light are substantially blocked by one or more fingers associated with the cover.

12. The speaker according to claim 8, where a first uncovered area appears illuminated and a second uncovered area appears dark when an observer is in a first position and where a second uncovered area appears illuminated and the first uncovered area appears dark when the observer is in a second position.

13. The speaker according to claim 7, where the light disk includes an alignment mechanism.

14. A light assembly comprising:
a light source, a cover, and a light disk;
where the light disk includes a generally circular portion, the cover includes an outer periphery that generally corresponds to the outer periphery of the light disk, and where the cover is axially spaced from the light disk, the cover including a series of fingers extending axially toward the light disk and covering selected portions of an outer periphery of the light disk thereby forming covered and uncovered areas;
where the light disk includes a centrally located hole disposed on a first surface to receive the light source; and
where the light disk also includes a recess disposed on a second surface opposite the first surface.

15. The light assembly according to claim 14, where the recess has a conical shape to aid in refracting light towards an outer periphery of the light disk.

16. The light assembly according to claim 14, where a first plurality of uncovered areas appear illuminated and a second plurality of uncovered areas appear dark.

17. The light assembly according to claim 14, where a single uncovered area appears illuminated and remaining uncovered areas appear dark.

18. The light assembly according to claim 14, where an aligned ray of light is visible to an observer and adjacent rays of light are substantially blocked by one or more fingers associated with the cover.

19. The light assembly according to claim 14, where a first uncovered area appears illuminated and a second uncovered area appears dark when an observer is in a first position and wherein a second uncovered region appears illuminated and the first uncovered position appears dark when the observer is in a second position.

20. The light assembly according to claim 14, where the light disk includes an alignment mechanism to assist in aligning and mating with the cover.
